(19) United States
(12) Patent Application Publication
(10) Pub. No.: US 2006/0150021 A1
(43) Pub. Date: Jul. 6, 2006

(54) Device and method for analyzing embedded systems

(75) Inventors: Adrian Traskov, Steinbach (DE); Andreas Kirschbaum, Griesheim (DE); Thorsten Ehrenberg, Bad Nauheim (DE); Tasso Kirsch, Florsheim-Weilbach (DE); Burkart Voss, Dorndorf-Steudnitz (DE)

Correspondence Address: Gerlinde M Nattler;Continental Teves Inc, One Continental Drive, Auburn Hills, MI, 48326, US

(73) Assignee: Continental Teves AG & Co. oHG

(21) Appl. No.: 10/535,598

(22) PCT Filed: Nov. 12, 2003
(86) PCT No.: PCT/EP03/12630

§ 371 Date: Nov. 28, 2005

(30) Foreign Application Priority Data
Nov. 22, 2002 (DE) 10254788.2

(51) Int. Cl. G06F 11/00

(52) U.S. Cl. 714/37

(57) ABSTRACT

The invention discloses an analysis device for an embedded system (9) comprising a CPU (1), a CPU bus (2) and a memory (3). The embedded system has at least one communication module (4) for the input or output of analysis data by way of a test interface (5). The communication module permits the internal memory and the input and output access operations of the embedded system to be monitored and/or logged without using the clock cycles of the CPU (1).

### BACKGROUND OF THE INVENTION

The present invention relates to an analysis device for an embedded system, and a method for the analysis of an embedded system with an analysis device.

To successfully develop software for embedded systems, it is a general practice to provide devices enabling error detection during the operation time (debugging). In the known concept of debugging embedded systems by way of a so-called JTAG interface (Joint Test Action Group, IEEE Standard 1149.1-1990, ‘IEEE Standard Test Access Port and Boundary Scan Architecture’, Institute of Electrical and Electronics Engineers Inc., New York, USA, 1990) it is possible to perform testing operations by means of a ‘Boundary-Scan’ testing method. This method allows single-step processing of the processor (single stepping), the setting of break points (break points) and the setting of so-called watch points. Although these per se known auxiliary means for error detection permit monitoring the principal program execution and the condition of values of single variables, generally the running system must be stopped to this end. It is disadvantageous, however, that the output of the microcomputer can no longer be in real time.

The problem encountered is that embedded systems frequently are real time systems and, due to their typical range of application in real-time controls, do not allow being stopped for debugging purposes, not at least for checking the data changed in connection with the real time processing.

The so-called trace-interface is further known in the art, where the conduction of all relevant CPU bus signals (address signals, data signals and control signals) by way of housing pins e.g. to an external logic analysis device is enabled by using a ‘bond-out’ chip for the real time analysis. The bond-out chip is a microcontroller (MCU) in another casing, where the processor bus (data, address and control signals) is bonded towards the outside.

With the high system frequencies of several hundred megahertz being conventional nowadays for embedded systems and the modern memory architectures with caches, this method for the error analysis can no longer be used due to the high speed requirements. A real time output of relatively comprehensive data memories (for example, of a size of more than 100 kilobyte) is generally impossible due to the system frequencies predetermined on account of the technology employed and the resulting band width. One given possibility of creating the band width necessary for the real time data transfer would be a parallel output of the data to be transferred. However, the number of pins available for this purpose is normally limited, not least for cost reasons.

In view of the above, an object of the invention is to provide an analysis device for embedded systems, which can be employed also in the up-to-date quick embedded systems.

### SUMMARY OF THE INVENTION

This object is achieved by an analysis having a CPU, a CPU bas, a memory and a communication module.

The invention is based on the following reflections: On the one hand, the internal system condition of an embedded system can be described or analyzed, respectively, by way of its present data memory contents (RAM). From this follows that in case this memory content can be copied in real time into an external data memory, there is a possibility of further processing and evaluating the system condition from this point by means of a subsequent evaluation unit.

In the analysis device a copy of the internal system condition is preferably written in real time into an external memory.

The analysis device is preferably part of an embedded system, which is employed in particular in electronic control devices for motor vehicle brake systems. In the embedded system according to the invention, preferably basic components of the system such as one or more CPUs and memories are designed partly or fully redundantly. The safety of operation of the embedded system is hereby enhanced.

Preferably, the logging of data does not take place in such a fashion that the entire memory content or the content of a whole memory range is transmitted. Rather, only the changes in the memory, especially all write access operations of the CPU and/or the periphery are transmitted. A reduction of the necessary band width for the data output can take place this way.

Further, the system preferably comprises a means for the direct data output by the CPU. Apart from this means for the direct data output, especially a means for an automatic replication of the data in the background by way of the analysis module is provided. The result is the advantage of an increased flexibility in the data output.

Especially for these cases of application, the invention discloses a universal data input and output module configured in such a manner that in real time a data exchange can be carried out by means of an embedded system without having to stop (not even temporarily) this system (non-intrusive).

Compared to the software debugging devices known from the state of the art, the analysis device of the invention is advantageous in that in the development of control algorithms, e.g. for motor vehicle brake systems, the dynamic system behavior, especially the control variables, can be monitored during the debugging operation. It is furthermore favorable that a data input into the embedded system can be carried out for the employment of an embedded system in a hardware-in-the-loop simulator or in a rapid-prototyping system.

Another objective of the invention is a method for the analysis of an embedded system as described hereinabove with an analysis device having a CPU, a CPU bus, a memory and a communication module.

The method is advantageous in that the processing speed of the embedded system is not reduced on account of the debugging processes running in the background. This condition renders possible a real time processing of the data even during the debugging operation.

Preferably, the method of the invention also comprises steps for the output of the complete data memory contents in real time.

### BRIEF DESCRIPTION OF THE DRAWING

FIG. 1 illustrates an analysis device.

### DETAILED DESCRIPTION OF THE DRAWING

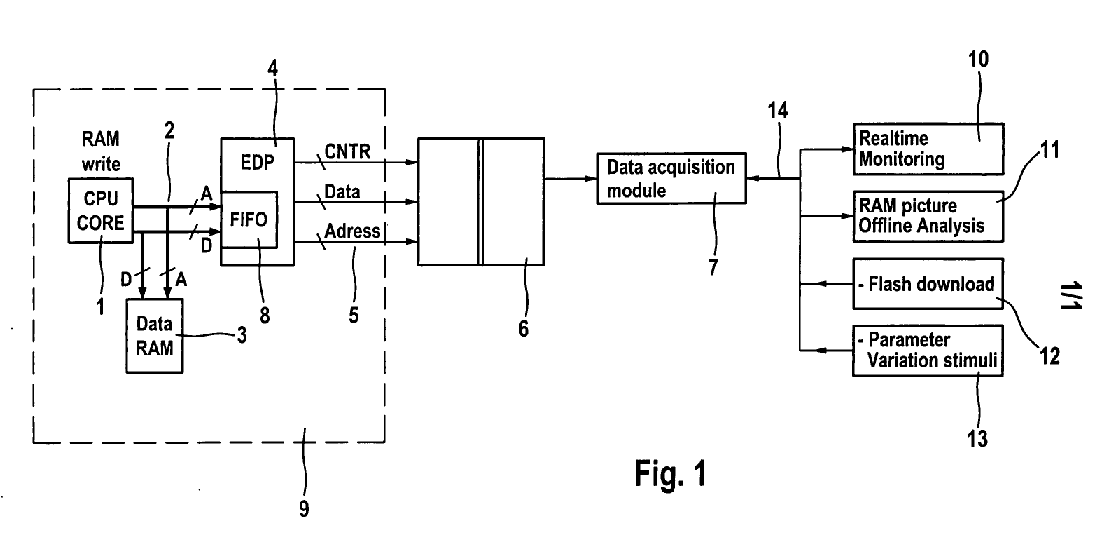

The analysis device of the invention and the method of the invention will be described in the following by way of embodiments while making reference to FIG. 1.

FIG. 1 shows an embedded system 9 with an analysis device 4 according to the invention.

The embedded system 9 comprises one or more CPUs 1, one RAM 3, an analysis device 4 and a debugging interface 5. To simplify the wiring diagram, further conventional functional elements of the embedded system such as ROM, clock generation, IO, etc., are not illustrated.

The analysis device includes three function modes that will be described hereinbelow. In function mode 1 the analysis device reads for control all write access operations of the CPU 1 to the data memory 3. This means all write access operations of the CPU 1 to the data memory 3 are written automatically by way of CPU bus 2 by the suggested extended data output/input unit 4 (EDP, Enhanced Data Port) by means of a controller contained therein by way of a parallel interface 5 to the external data memory 6. To this end, the controller must have at least the same band width as the memory 3 used. Beside a connection to the data bus, the controller has in particular a connection to the control bus and to the address but in order that, according to a preferred embodiment of the method, only especially selected address ranges and/or especially selected data types can be monitored for the analysis. Accordingly, CPU 1 does not have to execute additional commands for tapping the data and for the data transfer.

The external data memory 6 is preferably designed as a dual-port memory and usually contains an exact reproduction of the memory ranges monitored in RAM 3 or the entire memory content of RAM 3, respectively. Memory 6 can also be a magnetic core memory storing the arriving data flow for a later (offline) analysis.

External interface 5 preferably has a band width that is smaller than the band width of the CPU bus. FIFO memory 8, which is arranged within the data output unit 4, ensures a time buffer of the tapped data. It is this way possible to output also accesses to interface 5 where a cache line or a CPU register dump is re-written upon entry into the function.

In the function mode 2 the analysis device 4 reads for control all reading access operations of CPU 1 to the data memory. This mode largely corresponds to function mode 1, however, there are the following differences: all reading access operations are automatically output by way of interface 5. Analysis unit 4 then registers all operations such as read cycles, write cycles, etc., which are visible on the CPU bus (read for control). In function mode 2 CPU 1 actively performs a memory dump entailing, however, an insignificant tolerable loss in running time. Due to the analysis unit 4 reading for control, the number of clock cycles necessary for the output of data words for the analysis are reduced or even avoided, respectively.

CPU 1 reads the data memory content into the registers (not shown) of the CPU. The data available in the registers can then be written in analysis unit 4. The mode of function described herein basically corresponds to the function mode 3 that will be described hereinbelow.

In the analysis device suggested in the present example (function mode 2), CPU 1 reads the data memory content into the CPU registers. In parallel to this, the data output unit 4, which overhears the data bus, automatically outputs the corresponding data, i.e., there is no need for an explicit write cycle for the data output for the analysis.

In function mode 3 there is direct writing on the data output unit or direct reading from the data output unit. Thus, function mode 3 corresponds to function mode 1, apart from the fact that data is actively output by the CPU 1 externally to the analysis unit 4, or is read in actively from there, respectively, with the result, however, that additional clock cycles are necessary.

By way of module 7, the analysis unit can transfer data from the external memory 6 to typical debugging applications such as real-time monitoring of the system condition 10, offline analysis for creating a complete data memory reproduction by way of module 11, flash download by way of communication channel 12 (programming of the program memory), parameter variation during the operation of the embedded system, transfer of system stimuli, rapid prototyping and hardware-in-the-loop simulation.

1-20. (canceled)

21. An analysis device for an embedded system comprising:
a CPU;
a CPU bus;
a memory (3); and
at least one communication module for input or output of analysis data by way of a test interface, wherein the communication module permits the memory and input and output access operations of the embedded system to be monitored and/or logged without using clock cycles of the CPU.

22. The analysis device of claim 21, wherein at least three freely selectable analysis modes, with the analysis modes, in the way and extent of participation of the CPU, differing from each other in the read and/or write operations of data for analyzing purposes.

23. The analysis device of claim 22, wherein depending on the selected analysis mode, either
all write access operations of the CPU are logged to especially definable address ranges without using clock cycles, or
all read access operations of the CPU are logged, or
direct reading and writing of the CPU out of/into an external memory is executed by using clock cycles.

24. The analysis device of claim 23, wherein the communication module comprises a controller which, by way of a connection to at least a data bus, a control bus, or an address bus, can independently make access to the bus of the embedded system in order to monitor write and/or read access operations in real time, without influencing of the CPU.

25. The analysis device of claim 24, wherein the communication module is connected to a buffer store and the data transferred in write and/or read access operations can be stored in the buffer store.

26. The analysis device of claim 25, wherein the data can be output from the buffer store in a buffered fashion by way of the test interface or data can be read into the buffer store by way of the test interface.

27. The analysis device of claim 23, wherein the external memory is a magnetic core memory or a dual-port memory.

28. The analysis device of claim 21, wherein the communication module is integrated into the embedded system.

29. The analysis device of claim 21, wherein the test interface is connected to a test code memory arranged outside the embedded system.

30. The analysis device of claim 21, wherein the data transfer from the communication module to an external memory takes place by way of a parallel interface.

31. The analysis device of claim 30, wherein the external memory is connected to a data conditioning device providing an interface connection to external debugging applications.

32. An embedded system comprising and analysis device, the embedded system comprising:
a central processor unit;
a CPU bus;
a memory; and
at least one communication module for input or output of analysis data by way of a test interface, wherein the communication module permits the memory and input and output access operations of the embedded system to be monitored and/or logged without using clock cycles of the CPU.

33. A method for analyzing an embedded system comprising:
providing a central processor unit;
providing a CPU bus;
providing a memory;
providing at least one communication module having at least input element and at least one output element;
providing at least one mode for analyzing data in real time without requiring the system to be stopped or interrupted, respectively, for the analysis.

34. The method of claim 33, wherein
the memory content or a correspondingly assessable information of the embedded system, in whole or in part, is copied in real time into an external memory, with the data being buffered in particular before this operation, and/or
the data content of an external memory or a correspondingly assessable information about the memory content of the memory, in whole or in part, is copied in real time into a memory of the embedded system, with the data being buffered in particular before this operation.

35. The method of claim 34, wherein the external memory is used to transmit data for typical debugging applications.

36. The method of claim 35, wherein only the data needed for debugging is transferred to the external memory in the event of access operations of the CPU to

37. The method of claim 34, wherein at least the write access operations or the read access operations of the CPU are logged by means of a buffer store.

38. The method of claim 37, wherein information about the write access operations is written without additional CPU commands into the buffer store or directly into the communication module, and the information about the read access operations is written into the buffer store with active assistance of the CPU.

39. The method of claim 33, wherein a mode of the embedded system is provided in which all write and/or read access operations of the CPU are rerouted to the communication module.

40. The method of claim 33, wherein a mode of the embedded system is provided in which only either the write access operations or the read access operations of the CPU are rerouted to the communication module, and the other access operations of the CPU to the memory are logged actively by the CPU into the external memory.
